(19) United States
(12) Patent Application Publication
(10) Pub. No.: US 2018/0137291 A1
(43) Pub. Date: May 17, 2018

(54) SECURING FILES AT REST IN REMOTE STORAGE SYSTEMS

(71) Applicant: LinkedIn Corporation, Sunnyvale, CA (US)

(72) Inventors: Albert M. Ho, Santa Clara, CA (US); Qi Liu, Saratoga, CA (US); Mark I. Sandori, San Jose, CA (US)

(73) Assignee: LinkedIn Corporation, Sunnyvale, CA (US)

(21) Appl. No.: 15/350,776

(22) Filed: Nov. 14, 2016

(51) Int. Cl. G06F 21/60; G06F 17/30; G06F 9/455

(52) U.S. Cl. CPC G06F 21/602; G06F 17/30091; G06F 9/45504; G06F 17/30235; G06F 17/3012

(57) ABSTRACT

The disclosed embodiments provide a system for managing access to a remote storage system. During operation, the system receives a first request from a user to write a file to a remote storage system. Next, the system receives a first encrypted version of the file from a client associated with the first request. The system then decrypts the first encrypted version to obtain an unencrypted version of the file and uses the unencrypted version to generate a second encrypted version of the file. Finally, the system writes the second encrypted version to a file store and stores metadata for the file in a virtual filesystem that is physically separate from the file store.

### RELATED APPLICATION

The subject matter of this application is related to the subject matter in a co-pending non-provisional application by the same inventors as the instant application and filed on the same day as the instant application, entitled “Secure Virtualization of Remote Storage Systems,” having serial number TO BE ASSIGNED, and filing date TO BE ASSIGNED (Attorney Docket No. LI-P2078.LNK.US).

### BACKGROUND

### Field

The disclosed embodiments relate to remote storage systems. More specifically, the disclosed embodiments relate to techniques for securing files at rest in remote storage systems.

### Related Art

Data on network-enabled devices is commonly synchronized, stored, shared, and/or backed up on remote storage systems such as file hosting services, cloud storage services, and/or remote backup services. For example, data such as images, audio, video, documents, executables, and/or other files may be stored on a network-enabled electronic device such as a personal computer, laptop computer, portable media player, tablet computer, and/or mobile phone. A user of the electronic device may use a file transfer protocol to write files from the electronic device to a remote storage system, read files from the remote storage system to the electronic device, and/or otherwise access a remote filesystem on the remote storage system.

However, existing remote storage systems are associated with a number of drawbacks. First, files that are written to a remote storage system are commonly stored in an unencrypted state. Second, the files are typically persisted locally, thus requiring a user to access the same physical machine to read files that were previously uploaded by the user. Third, file metadata is typically representative of the file as it exists within the uploader's local file system, exposing potentially sensitive information of the uploader. Fourth, user access is typically not federated, creating a maintenance burden for onboarding or offboarding new users. Consequently, use of remote storage systems may be improved by mechanisms for securing and/or scaling access to the remote storage systems.

### BRIEF DESCRIPTION OF THE FIGURES

FIG. 1 shows a schematic of a system in accordance with the disclosed embodiments.

FIG. 2 shows a system for managing access to a remote storage system in accordance with the disclosed embodiments.

FIG. 3 shows an exemplary sequence of operations involved in accessing a remote storage system in accordance with the disclosed embodiments.

FIG. 4 shows an exemplary sequence of operations involved in accessing a remote storage system in accordance with the disclosed embodiments.

FIG. 5 shows a flowchart illustrating the process of managing access to a remote storage system in accordance with the disclosed embodiments.

FIG. 6 shows a flowchart illustrating the processing of a request to access a remote storage system in accordance with the disclosed embodiments.

FIG. 7 shows a flowchart illustrating the processing of a request to access a remote storage system in accordance with the disclosed embodiments.

FIG. 8 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

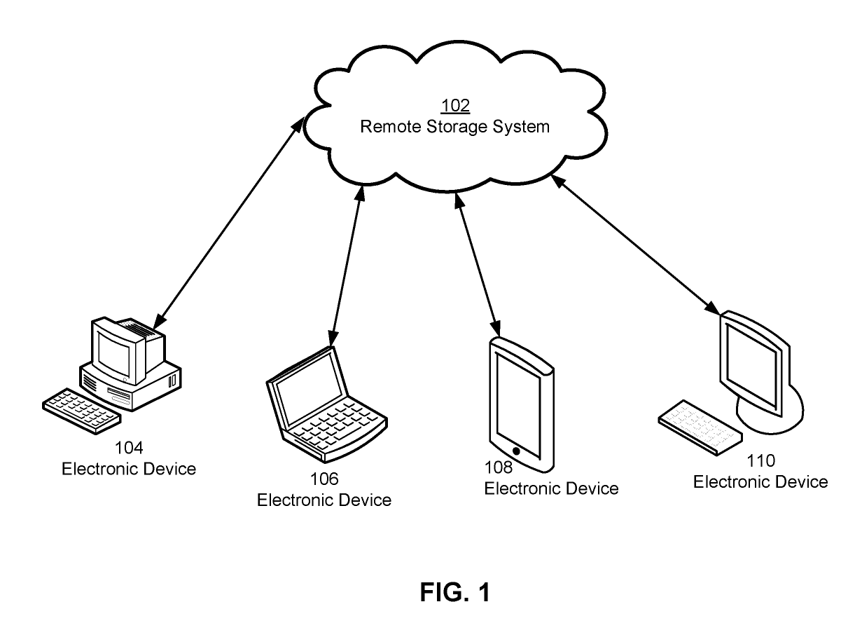

The disclosed embodiments provide a method, apparatus, and system for managing access to a remote storage system. As shown in FIG. 1, a remote storage system 102 may be accessed from a set of electronic devices 104-110 such as personal computers, laptop computers, tablet computers, mobile phones, personal digital assistants, portable media players, digital media receivers, and/or other network-enabled electronic devices. Communication between the electronic devices and remote storage system may be enabled by one or more networks, such as a local area network (LAN), wide area network (WAN), personal area network (PAN), virtual private network, intranet, cellular network, WiFi network, Bluetooth (Bluetooth™ is a registered trademark of Bluetooth SIG, Inc.) network, universal serial bus (USB) network, and/or Ethernet network.

During use of remote storage system 102, users of electronic devices 104-110 may perform tasks related to storage, backup, retrieval, sharing, and/or synchronization of data. For example, each user may use an electronic device to store images, audio, video, documents, executables, and/or other files with a user account of the user on the remote storage system. To access the files and/or user account, the user may provide authentication credentials for the user account from the electronic device to the remote storage system. The user may also enable access to the files from other devices and/or users by providing the same authentication credentials to the remote storage system from the other electronic devices, authorizing access to the files from user accounts of the other users, and/or placing the files into a publicly accessible directory on remote storage system 102.

To provide functionality related to data storage, backup, sharing, synchronization, and/or access, remote storage system 102 may store the data using one or more storage mechanisms. For example, the remote storage system may use one or more servers, cloud storage, network-attached storage (NAS), a storage area network (SAN), a redundant array of inexpensive disks (RAID) system, and/or other network-accessible storage to store the data. The remote storage system may additionally store the data using a variety of filesystem architectures and/or hierarchies and obscure the physical locations and/or mechanisms involved in storing the data from electronic devices 104-110.

Electronic devices 104-110 may also use one or more network protocols to access and/or use remote storage system 102. For example, the electronic devices may use Secure Shell (SSH), SSH File Transfer Protocol (SFTP), secure copy (SCP), and/or another remote shell and/or file transfer protocol to read, write, create, delete, and/or modify files and/or directories in the remote storage system.

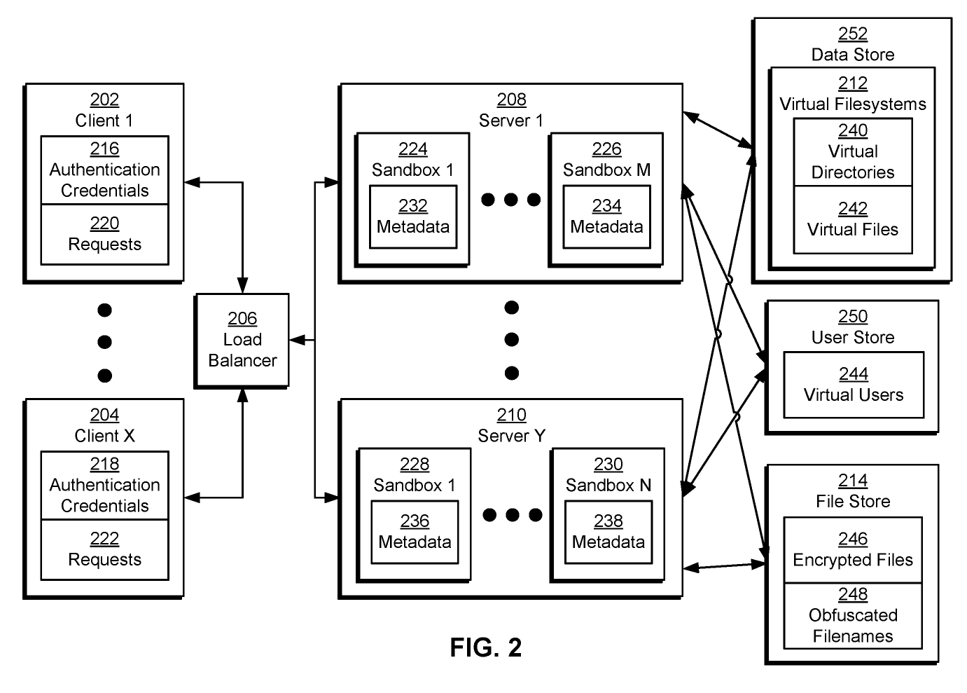

In one or more embodiments, remote storage system 102 includes functionality to improve the security, scalability, and/or ease of deployment associated with access to files on the remote storage system from electronic devices 104-110. As shown in FIG. 2, access to a remote storage system (e.g., remote storage system 102 of FIG. 1) by a number of clients (e.g., client 1 202, client x 204) may be managed using a load balancer 206, a number of servers (e.g., server 1 208, server y 210), a data store 252, a file store 214, and a user store 250. Each of these components is described in further detail below.

File store 214 may store representations of files in the remote storage system as encrypted files 246 with obfuscated filenames 248. For example, the file store may be provided by a distributed and/or replicated Binary Large Object (BLOB) storage system that is physically separate from other components (e.g., load balancer 206, servers, virtual filesystem 212, user store 250) of the remote storage system. Within the file store, data may be encrypted using a symmetric key encryption technique, and filenames may be obfuscated using a hash function. Encrypted files and obfuscated filenames in the file store may thus secure the files and/or corresponding filenames against access from attackers and/or other unauthorized users.

Virtual filesystems 212 in data store 252 may include representations of virtual directories 240 and virtual files 242 that are used to organize data in file store 214. For example, each virtual filesystem may store metadata (e.g., metadata 232-238) that is used to construct a directory structure for storing and/or accessing encrypted files 246 in file store 214. Because metadata used to access the encrypted files and the encrypted files are maintained in physically separate data stores (i.e., the data store and file store), data in the remote storage system may further be secured against unauthorized access.

User store 250 may maintain records of virtual users 244 in the remote storage system. Each virtual user may be associated with a unique identifier, authentication credentials, expiration times for the authentication credentials, access permissions, groups, hierarchies, and/or other metadata related to access to the remote storage system by the virtual user.

As described in further detail below, encrypted files 246 in file store 214, virtual filesystems 212 in data store 252, and virtual users 244 in user store 250 may be used to provide scalable, secure virtualization of the remote storage system. For example, the system of FIG. 2 may be used to provide SFTP, SCP, and/or other types of file transfer functionality without requiring manual configuration of individual servers with physical user accounts and/or resources for accessing conventional remote storage systems.

More specifically, servers in the remote storage system may use data store 252, file store 214, and user store 250 to manage access to the remote storage system during user sessions between the clients and the remote storage system. To initiate each user session, a client executing on an electronic device (e.g., electronic devices 104-110 of FIG. 1) may provide authentication credentials (e.g., authentication credentials 216-218) for a user of the remote storage system. For example, the client may transmit a username, password, biometric fingerprint, digital certificate, security token, public key, personal identification number (PIN), knowledge-based authentication factor, and/or pattern factor in a request (e.g., requests 220-222) to connect to the remote storage system. The request may be received by load balancer 206 and routed to a server based on a round-robin load-balancing technique, another load-balancing technique, and/or current loads of the servers.

After the connection request is received by a server, the server may use the authentication credentials to perform authentication of the user against user store 250. For example, the server may query the user store for a virtual user that matches the authentication credentials. If a matching virtual user is found, the user of the client is authenticated. Because the virtual users are managed separately from physical user accounts, home directories, authentication credentials, and/or other resources associated with access to the servers, users of the clients may provide authentication credentials to any server to initiate access to the remote storage system. In turn, the servers may be deployed in a scalable and/or stateless way instead of requiring replication of physical user accounts, directories, and/or other resources across multiple machines in a conventional remote storage system.

Next, the server may create a user session for accessing the remote storage system as the virtual user. Once the user session is initiated, the server may create a sandbox (e.g., sandbox 1 224, sandbox m 226, sandbox 1 228, sandbox n 230) for accessing the remote storage system by the virtual user. The sandbox may include a highly controlled environment for accessing a restricted set of resources, which may limit or prevent attackers from gaining unauthorized access to the server or remote storage system. The server may also configure the sandbox with a set of permissions for the virtual user, such as read, write, and/or execute permissions for various files and/or directories in the remote storage system. When the user session is terminated, the server may destroy (e.g., terminate) the sandbox. By configuring access to the remote storage system using sandboxes and virtual users, the system of FIG. 2 may allow arbitrary sets of users to share the same physical server and associated resources (e.g., processor, memory, etc.) in a secure, flexible manner.

The server may also mount a virtual filesystem (e.g., virtual filesystems 212) for the virtual user in the sandbox. For example, the server may identify and/or retrieve metadata (e.g., metadata 232-238) describing one or more virtual directories 240 and/or virtual files 242 in the virtual filesystem from data store 252. The server may use the metadata to create a representation of the virtual filesystem in the sandbox. The server may then use the sandbox and virtual filesystem to process additional requests (e.g., requests 220-222) to access the remote storage system from the client. The server may also enable sharing of sandboxes among users, when allowed by permissions for the users. For example, one user may upload files from one client to a sandbox. After a given file is uploaded, the server may grant access to the sandbox to another user, thus allowing additional users to remotely download and/or access the files from the sandbox. Additionally, the server may write files into the virtual filesystem of a particular user or users, thus allowing distribution of a file to a group of users or the entire user base.

More specifically, each virtual filesystem may be defined in data store 252 using a virtual home directory for the virtual user and/or a number of virtual files 242 and/or sub-directories below the virtual home directory. Each sub-directory may also include a number of additional sub-directories and/or virtual files in the virtual filesystem. Each directory in the virtual filesystem may be defined using a directory record that identifies the virtual user, a path of the directory, a creation time of the directory, a parent directory of the directory, and/or child directories of the directory and/or files in the directory. Each virtual file in the virtual filesystem may be defined using a file record that specifies a filename of a corresponding file in the remote storage system, an obfuscated filename of the file in file store 214, an upload time, a file size, a status (e.g., processed, unprocessed, error, deleted, expired, etc.), and/or an expiration time of the file. In turn, data in the file record may be used to access an encrypted file represented by the virtual file in file store 214.

To obtain the virtual filesystem definition from data store 252, the server may retrieve the record for the user's virtual home directory from the data store, traverse records of virtual files and sub-directories under the virtual home directory, and write metadata representing the files and sub-directories to the sandbox. For example, the server may match an identifier for the virtual user from user store 250 to a record for a virtual home directory in the data store. Next, the server may use references in the record and/or the identifier for the virtual user to identify additional records for sub-directories and/or virtual files in the virtual filesystem.

The server may then use the records from data store 252 to construct the sandbox in the virtual filesystem. First, the server may create a virtual root directory representing the virtual filesystem. The virtual root directory may be created as a physical directory that is below a physical root directory on which the server runs. For example, the server may create the virtual root directory as a physical directory under a “/virtualpaths” path in the server, with the name of the physical directory set to the username and/or another identifier for the virtual user. To enforce permissions for the virtual user in the sandbox, the server may restrict the virtual user from accessing any directories above the virtual root directory, which may be performed natively using the filesystem implementation on the operating system of the server and/or virtually through the use of filesystem metadata.

The server may then use other directory and/or file records associated with the virtual user to construct corresponding sub-directories and virtual files below the physical directory representing the virtual root directory. Each virtual file may be a “fake” file that lacks meaningful content but contains metadata (e.g., metadata 232-238) from the corresponding file record. For example, metadata for the virtual file may include the filename, upload time, file size, status, expiration time, and/or other information from the file record of the virtual file in the data store. The metadata may additionally include a “virtual” flag to indicate that the virtual file does not contain real file data. If the metadata indicates that the corresponding file has been deleted or is expired, the server may omit creation of the virtual file in the virtual filesystem. The server may optionally obfuscate filenames and/or other metadata on a per-session basis so that different obfuscated filenames are shown any time a malicious user attempts to gain access to the physical filesystem on the machine.

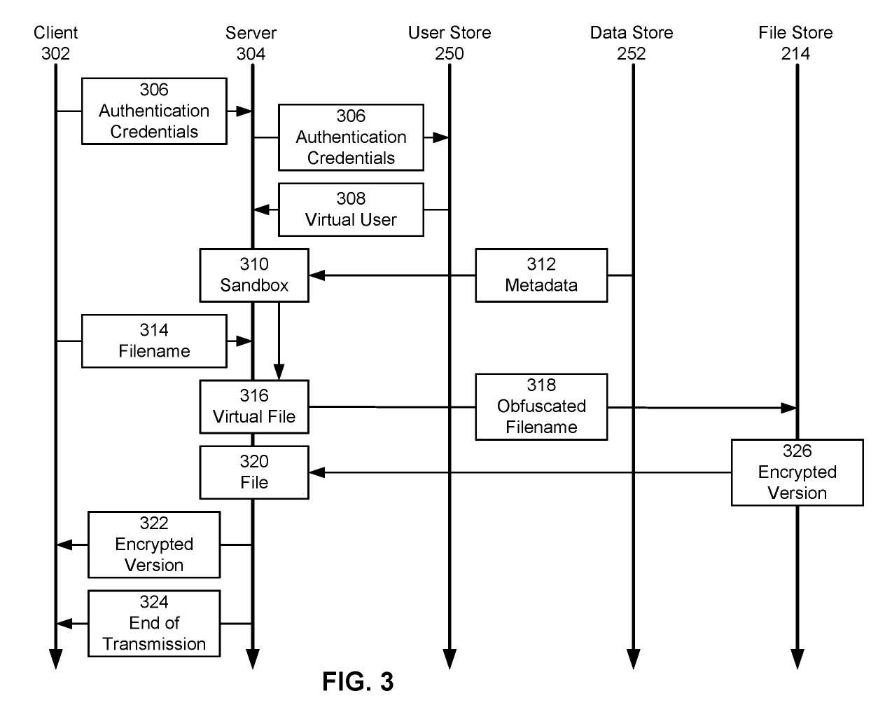

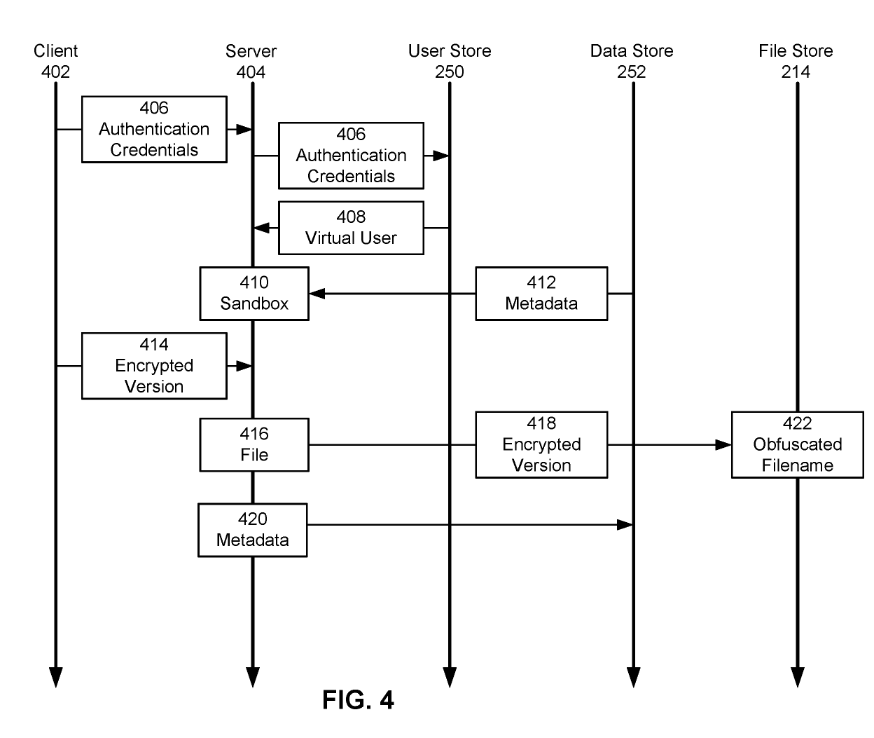

After the virtual filesystem is mounted in the sandbox, the server may use the virtual filesystem and file store 214 to access and manipulate the corresponding files and/or directories in response to requests from the client. Such requests may be similar and/or identical to commands associated with a remote shell protocol, file transfer protocol, and/or other network protocol used to access a remote storage system. First, the server may process a listing request (e.g., “ls”) by using the metadata in the virtual filesystem to generate a listing of files in the virtual filesystem. Within the listing, the server may include the original filenames of the files instead of obfuscated filenames 248 in file store 214. Second, the server may process a read request (e.g., “get”) by using the metadata and/or using a hash function (e.g., a one-time hash generated on a per-session basis) to match a filename in the read request to an obfuscated filename in the file store, retrieving an encrypted file with the obfuscated filename from the file store, decrypting the encrypted file, re-encrypting the file, and transmitting the re-encrypted file to the client, as described in further detail below with respect to FIG. 3. Third, the server may process a write request (e.g., “put”) by receiving an encrypted version of a file from the client, decrypting the encrypted version to obtain the original file, writing a different encrypted version of the file to the file store, setting an obfuscated filename for the file in the file store, and updating the virtual filesystem and/or sandbox with metadata associated with the file, as described in further detail below with respect to FIG. 4.

Those skilled in the art will appreciate that the system of FIG. 2 may be implemented in a variety of ways. First, load balancer 206, the servers, data store 252, file store 214, and user store 250 may be provided by a single physical machine, multiple computer systems, one or more virtual machines, a grid, one or more databases, one or more filesystems, and/or a cloud computing system. Second, the load balancer, servers, data store, file store, and/or user store may be scaled to the request volume and/or amount of processing or storage associated with the remote storage system. Third, the functionality of the system may be adapted to accommodate various file transfer protocols, secure shell protocols, and/or other network protocols for accessing a remote storage system. For example, the system may be configured to replicate and/or imitate the user authentication and process commands associated with a file transfer protocol such as SFTP or SCP without implementing and/or deploying the protocol in the remote storage system.

FIG. 3 shows an exemplary sequence of operations involved in accessing a remote storage system (e.g., remote storage system 102 of FIG. 1) in accordance with the disclosed embodiments. More specifically, FIG. 3 shows a sequence of operations involved in reading a file from the remote storage system.

As shown in FIG. 3, access to the remote storage system may begin with transmission of authentication credentials 306 for a user from a client 302 to a server 304. For example, the client may execute on a personal computer, laptop computer, tablet computer, mobile phone, portable media player, and/or other network-enabled device. The client may transmit a public key, username and password, biometric identifier, and/or other authentication factor for the user to the server.

Next, server 304 may provide authentication credentials 306 to user store 250 to identify a virtual user 308 associated with the authentication credentials. For example, the server may query the user store for an identifier and/or other data associated with a virtual user that matches the authentication credentials. If the authentication credentials match one or more records in the user store, the user store may return some or all of the data in the record(s) in a response to the query, and the user may be authenticated as the virtual user.

After the user is authenticated, server 304 may initiate a user session for the virtual user and create a sandbox 310 for accessing the remote storage system by the virtual user. More specifically, the server may use metadata 312 from data store 252 to configure the sandbox for accessing the virtual filesystem. For example, the server may create a virtual root directory representing a virtual filesystem for the virtual user in the sandbox. The server may also create a set of virtual files and/or sub-directories within the virtual root directory. The virtual files may contain metadata for files in file store 214 but lack real file data from the files.

Within each virtual file, the metadata may specify attributes such as, but not limited to, a filename, an obfuscated filename of the corresponding file in file store 214, an upload time, a file size, a status (e.g., processed, unprocessed, error, deleted, expired, etc.), and/or an expiration time. The obfuscated filename may be omitted if a hash function is used to map the filename to the obfuscated filename. If the metadata indicates that the file has been deleted and/or is expired, creation of the virtual file in the sandbox may be omitted. If the metadata indicates that the file is not deleted or expired, the virtual file may be created to have the same file size as the file and/or to mimic other attributes of the file. The metadata may also be copied to the virtual file to allow the file to be identified and/or retrieved from the file store using the virtual filesystem.

Server 304 may also configure sandbox 310 with a set of permissions for the virtual user. For example, the server may prohibit the user from accessing to any parent directory of the virtual root directory. The server may also enforce read, write, and/or execute permissions associated with the virtual user for files and/or directories in the virtual filesystem.

After sandbox 310 is configured for access to virtual filesystem 212, server 304 may process requests to access the virtual filesystem from client 302. As shown in FIG. 3, the server may receive a read request containing a filename 314 of a file in the remote storage system. The server may match the filename to a virtual file 316 in sandbox 310 and obtain an obfuscated filename 318 from metadata in the virtual file. The server may then use the obfuscated filename to request the file from file store 214.

In response to the request from server 304, file store 214 may transmit an encrypted version 326 of the file that matches obfuscated filename 318 to server 304. As the encrypted version is received in network packets from the file store, the server may decrypt the encrypted version to obtain the original unencrypted file 320. For example, the server may use a symmetric key to decrypt packet payloads containing portions of the encrypted file as the packets are received from the file store.

During decryption of encrypted version 326 into file 320, server 304 may re-encrypt the file into a different encrypted version 322 and transmit portions of encrypted version 322 to client 302 as the portions are requested by the client. For example, the client may use SFTP, SCP, and/or another file transfer or network protocol to manage streaming of the file from the remote storage system by requesting a fixed number of bytes from the unencrypted file 320, starting at a given offset in the file. After the requested bytes are received from the server (e.g., as part of encrypted version 322), the client may send an acknowledgement and/or response requesting the next fixed number of unencrypted bytes from the file. Thus, when the server receives a request for a fixed number of bytes from the file, the server may use authentication credentials 306 associated with virtual user 308 to re-encrypt the requested bytes and transmit the bytes in a series of network packets to the client. Consequently, the remote storage system may use two separate cryptographic techniques to securely store files in file store 214 and securely transmit the files to client 302.

On the other hand, the number of unencrypted bytes requested by client 302 may be different from the number of bytes in encrypted version 326 that need to be decrypted to produce the unencrypted bytes. To manage file size differences between the decrypted and encrypted versions of the file, server 304 may track the decryption of bytes from encrypted version 326 into file 320 as the encrypted version is received from file store 214. For example, the server may decrypt a portion of the encrypted version until the requested number of decrypted bytes is reached. The server may re-encrypt the decrypted bytes as a portion of encrypted version 322 and transfer the portion to the client. The server may also track an offset in the encrypted version representing the point up to which the encrypted version has been decrypted. After a subsequent request for a fixed number of decrypted bytes is received from the client, the server may resume decrypting of the encrypted version from the offset and subsequent re-encryption and transfer of the requested bytes to the client. After the entire encrypted version 326 is decrypted, the server may re-encrypt and transmit any remaining bytes in the file to the client, along with an end of transmission 324 message that signals completion of the file transfer to the client.

FIG. 4 shows an exemplary sequence of operations involved in accessing a remote storage system (e.g., remote storage system 102 of FIG. 1) in accordance with the disclosed embodiments. More specifically, FIG. 4 shows a sequence of operations involved in writing a file to the remote storage system.

As with the sequence of FIG. 4, the sequence of FIG. 4 begins with transmission of authentication credentials 406 for a user from a client 402 to a server 404. The server may provide the authentication credentials to user store 250 to identify a virtual user 408 associated with the authentication credentials. The server may then create a user session and sandbox 410 for the virtual user. After the sandbox is created, the server may use metadata 412 from data store 252 to configure the sandbox for accessing the remote storage system by the virtual user, as described above.

During the user session, client 406 may transmit an encrypted version 414 of a file 416 with a request to write the file to the remote storage system. Server 404 may receive the encrypted version and write request and use authentication credentials 406 for virtual user 408 to decrypt the encrypted version into file 416. Next, the server may use a symmetric key to generate another encrypted version 418 of the file and transmit encrypted version 418 to file store 214. Once the end of the file is reached during generation of encrypted version 418, the server may pad the remaining, unencrypted portion of the file (e.g., to produce a fixed block size that can be encrypted using the symmetric key), encrypt the portion, and transmit the portion to the file store. Conversely, padding may be omitted when encrypted version 418 is generated using a stream cipher.

After encrypted version 418 is received in file store 214, the encrypted version is stored under an obfuscated filename 422, such as a hash of the original filename of file 416. The obfuscated filename may be omitted if a consistent hash is used to produce the obfuscated filename from the original filename. In turn, server 404 may remove the encrypted version from sandbox 410 and replace the encrypted version with a virtual file containing metadata 420 for the file. The server may also update the metadata to indicate that the file has been processed (e.g., stored) in the remote storage system. Finally, the server may transmit the metadata to virtual filesystem 212 to allow subsequent access to the file in the remote storage system.

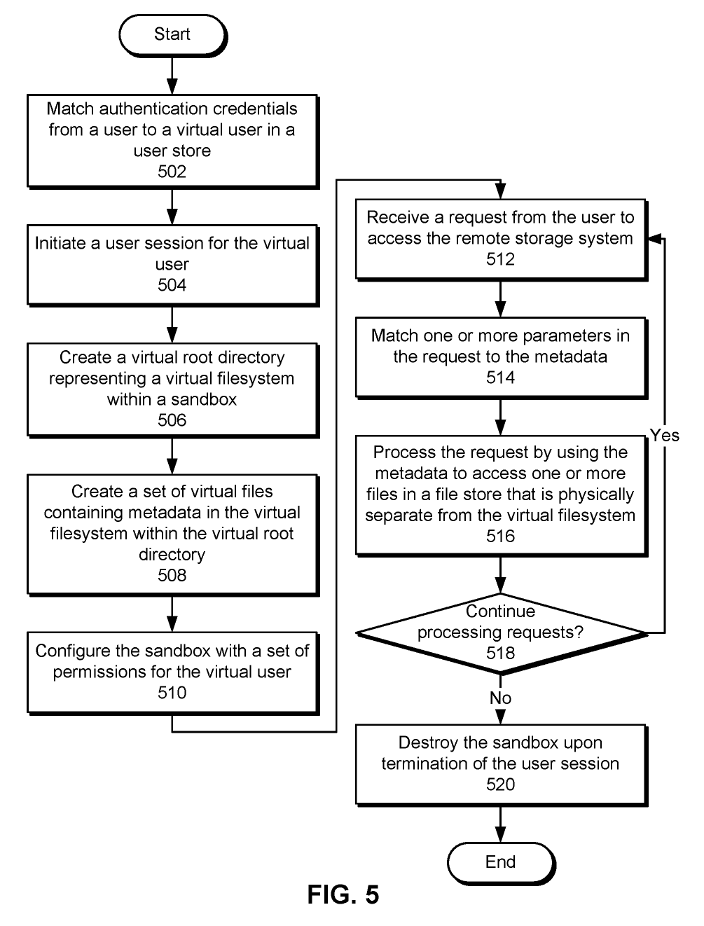

FIG. 5 shows a flowchart illustrating the process of managing access to a remote storage system in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

Initially, authentication credentials from a user are matched to a virtual user in a user store (operation 502). For example, a public key, username and password, biometric identifier, digital certificate, and/or another authentication factor may be received from a client associated with the user. The authentication credentials may be provided in a query to the user store, and the user store may transmit an identifier and/or other data for the virtual user in a response to the query.

Next, a user session for the virtual user is initiated (operation 504).

Upon initiation of the user session, a sandbox for accessing the remote storage system by the virtual user is created. In particular, a virtual root directory representing a virtual filesystem is created within the sandbox (operation 506), and a set of virtual files containing metadata in the virtual filesystem is created within the virtual root directory (operation 508). The metadata may include a filename, an obfuscated filename, an upload time, a file size, a status, and/or an expiration time. When the metadata associated with a virtual file includes a deleted and/or expired state, creation of the virtual file in the virtual root directory may be omitted.

The sandbox is also configured with a set of permissions for the virtual user (operation 510). For example, the virtual user may be restricted from accessing any parent directories of a physical directory representing the virtual root directory. Read, write, execute, and/or other permissions associated with files and/or subdirectories in the virtual filesystem may also be enforced for the virtual user.

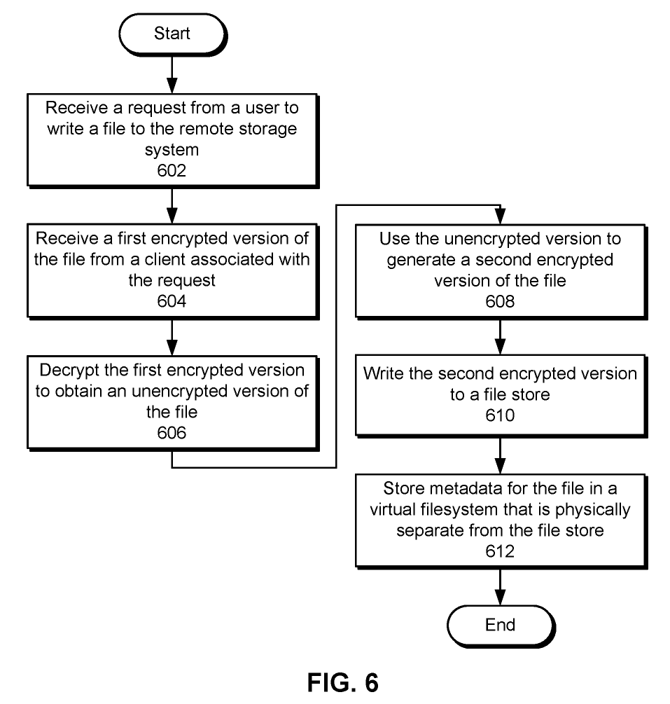

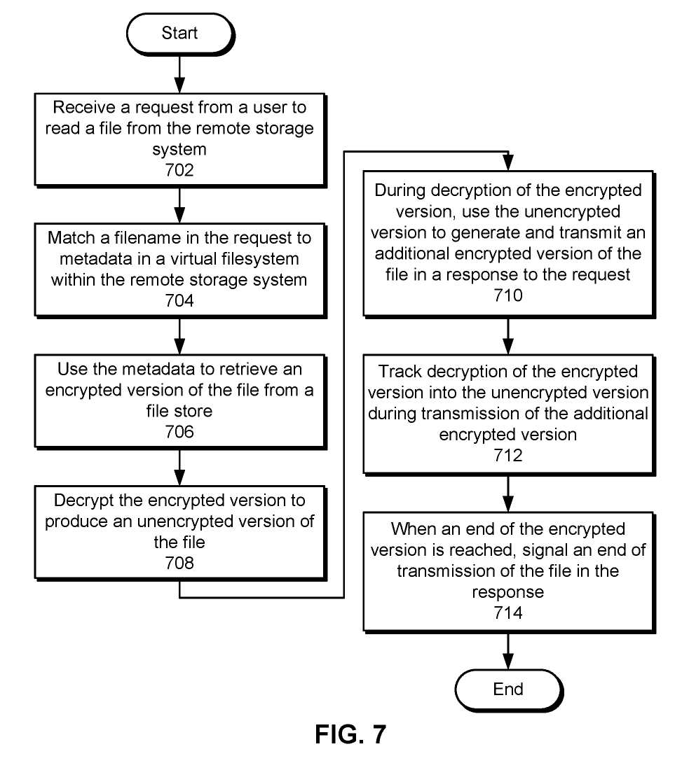

After the sandbox is created and configured, requests to access the remote storage system may be processed for the user. More specifically, each request from the user may be received (operation 512), and one or more parameters in the request may be matched to the metadata (operation 514) in the virtual filesystem. The request is then processed by using the metadata to access one or more files in a file store that is physically separate from the virtual filesystem (operation 516). For example, the metadata may be used to generate a listing of files in the virtual filesystem in response to a listing request. The metadata may also be used to process read or write requests, as described in further detail below with respect to FIGS. 6-7.

Processing of requests to access the remote storage system in operations 512-516 may continue (operation 518) during the user session. Finally, the sandbox is destroyed upon termination of the user session (operation 520).

FIG. 6 shows a flowchart illustrating the processing of a request to access a remote storage system in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the technique.

First, a request to write a file to the remote storage system is received (operation 602), along with a first encrypted version of the file from a client associated with the request (operation 604). The first encrypted version may be received over a network connection with the client. As a result, the first encrypted version may prevent unauthorized access to the file by an eavesdropper and/or other unauthorized user. Next, the first encrypted version is decrypted to obtain an unencrypted version of the file (operation 606). For example, the first encrypted version may be decrypted using authentication credentials associated with the request, such as authentication credentials for a virtual user of the remote storage system.

The unencrypted version is then used to generate a second encrypted version of the file (operation 608), which is written to a file store (operation 610). For example, a symmetric key technique may be used to produce the second encrypted version from the unencrypted version. A portion of the unencrypted version (e.g., the last portion of the file) may optionally be padded prior to encrypting the portion to produce a fixed block size for encryption (e.g., when a block cipher is used to produce the second encrypted version). Operations 606-610 may be performed at the same time, so that the first encrypted version is decrypted into a stream that is subsequently re-encrypted to generate the second encrypted version. By performing stream-based decrypting and re-encrypting of the file, the file is never stored in memory in an entirely decrypted state, thus enhancing the security of the remote storage system.

Finally, metadata for the file is stored in a virtual filesystem that is physically separate from the file store (operation 612). For example, the metadata may be stored in a virtual file within a virtual root directory mounted in a sandbox for accessing the remote storage system and/or within a record of the virtual file in a data store that is used to construct the virtual filesystem.

FIG. 7 shows a flowchart illustrating the processing of a request to access a remote storage system in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the technique.

First, a request from a user to read a file from the remote storage system is received (operation 702). Next, a filename in the request is matched to metadata in a virtual filesystem within the remote storage system (operation 704). For example, the filename may be matched to metadata in a virtual file within the virtual filesystem. The virtual file may be created within a sandbox for accessing the remote storage system, as discussed above.

The metadata is used to retrieve an encrypted version of the file from a file store (operation 706). For example, a mapping of the filename of the file to an obfuscated filename may be obtained from the metadata, and a file representing the encrypted version with the obfuscated filename may be retrieved from the file store. The encrypted version is then decrypted to produce an unencrypted version of the file (operation 708). For example, the encrypted version may be decrypted using a symmetric key and/or other cryptographic technique.

During decryption of the encrypted version into the unencrypted version, the unencrypted version is used to generate and transmit an additional encrypted version of the file in a response to the request (operation 710). For example, a fixed number of bytes of the unencrypted version may be requested at a given time from a client used to access the remote storage system. The encrypted version may be decrypted into the fixed number of bytes and re-encrypted using a symmetric key for the user for secure transmission to the client. After the re-encrypted bytes are received by the client, the client may send an acknowledgement and response requesting an additional fixed number of bytes from the unencrypted version.

To manage differences in the encrypted and unencrypted sizes of the file, decryption of the encrypted version into the unencrypted version is tracked during transmission of the additional encrypted version (operation 712). For example, the encrypted version may be decrypted in batches in response to requests from the client for fixed numbers of bytes from the decrypted version. As the encrypted version is decrypted, the point in the encrypted version up to which decryption has been performed may be tracked. When the end of the encrypted version is reached during generation of the additional encrypted version, an end of transmission of the file is signaled in the response (operation 714), and any remaining bytes in the file are transmitted with the end of transmission.

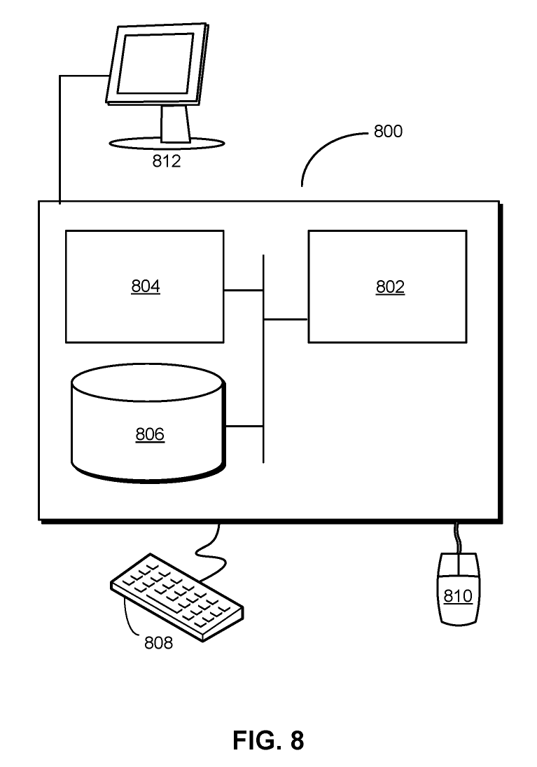

FIG. 8 shows a computer system in accordance with the disclosed embodiments. Computer system 800 may correspond to an apparatus that includes a processor 802, memory 804, storage 806, and/or other components found in electronic computing devices. Processor 802 may support parallel processing and/or multi-threaded operation with other processors in computer system 800. Computer system 800 may also include input/output (I/O) devices such as a keyboard 808, a mouse 810, and a display 812.

Computer system 800 may include functionality to execute various components of the present embodiments. In particular, computer system 800 may include an operating system (not shown) that coordinates the use of hardware and software resources on computer system 800, as well as one or more applications that perform specialized tasks for the user. To perform tasks for the user, applications may obtain the use of hardware resources on computer system 800 from the operating system, as well as interact with the user through a hardware and/or software framework provided by the operating system.

In one or more embodiments, computer system 800 provides a system for managing access to a remote storage system. The system includes a server that receives a request from a user to access a remote storage system. Next, the server may match one or more parameters in the request to metadata in a virtual filesystem in the remote storage system. The server may then process the request by using the metadata to access one or more files in a file store that is physically separate from the virtual filesystem.

During processing of a request to write a file to the remote storage system, the server may receive a first encrypted version of the file from a client associated with the request. Next, the server may decrypt the first encrypted version to obtain an unencrypted version of the file and use the unencrypted version to generate a second encrypted version of the file. The server may then write the second encrypted version to the file store and store metadata for the file in the virtual filesystem.

During processing of a request to read the file from the storage system, the server may match a filename in the request to the metadata in the virtual filesystem. Next, the server may use the metadata to retrieve the second encrypted version from the file store. The server may then decrypt the second encrypted version to produce the unencrypted version. During decryption of the second encrypted version, the server may use the unencrypted version to generate and transmit a third encrypted version of the file in a response to the second request.

In addition, one or more components of computer system 800 may be remotely located and connected to the other components over a network. Portions of the present embodiments (e.g., load balancer, servers, file store, user store, data store, etc.) may also be located on different nodes of a distributed system that implements the embodiments. For example, the present embodiments may be implemented using a cloud computing system that provides secure, virtualized access to a remote storage system by a set of users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
receiving a first request from a user to write a file to a remote storage system; and
processing, by a computer system, the first request by:
receiving a first encrypted version of the file from a client associated with the first request;
decrypting the first encrypted version to obtain an unencrypted version of the file;
using the unencrypted version to generate a second encrypted version of the file;
writing the second encrypted version to a file store; and
storing metadata for the file in a virtual filesystem that is physically separate from the file store.

2. The method of claim 1, further comprising:
receiving a second request to read the file from the remote storage system;
matching a filename in the second request to the metadata in the virtual filesystem;
using the metadata to retrieve the second encrypted version from the file store;
decrypting the second encrypted version to produce the unencrypted version; and
during decryption of the second encrypted version, using the unencrypted version to generate and transmit a third encrypted version of the file in a response to the second request.

3. The method of claim 2, further comprising:
tracking decryption of the second encrypted version into the unencrypted version during transmission of the third encrypted version; and
when an end of the second encrypted version is reached during generation of the third encrypted version, signaling an end of transmission of the file in the response.

4. The method of claim 2, wherein using the metadata to retrieve the second encrypted version from the file store comprises:
obtaining, from the metadata, a mapping of the filename to an obfuscated filename; and
retrieving a file representing the second encrypted version with the obfuscated filename from the file store.

5. The method of claim 2, wherein a symmetric-key technique is used to encrypt and decrypt the second encrypted version.

6. The method of claim 2, wherein the third encrypted version is generated using authentication credentials associated with the second request.

7. The method of claim 1, further comprising:
matching authentication credentials from the user to a virtual user in a user store;
upon initiation of a user session for the virtual user, creating a sandbox for accessing the virtual filesystem for the virtual user; and
configuring the sandbox with a set of permissions for the virtual user.

8. The method of claim 7, wherein creating the sandbox for accessing the virtual filesystem for the virtual user comprises:
creating a virtual root directory representing the virtual filesystem; and
creating a set of virtual files comprising the metadata within the virtual root directory.

9. The method of claim 1, wherein using the unencrypted version to generate the second encrypted version of the file comprises:
padding a portion of the unencrypted version prior to encrypting the portion.

10. The method of claim 1, wherein the metadata comprises at least one of:
a filename;
an upload time;
a file size;
a status;
an expiration time; and
an obfuscated filename in the file store.

11. The method of claim 1, wherein the virtual filesystem comprises:
a virtual root directory for the user;
one or more sub-directories under the virtual root directory; and
one or more files.

12. An apparatus, comprising:
one or more processors; and
memory storing instructions that, when executed by the one or more processors, cause the apparatus to:
receive a first request from a user to write a file to a remote storage system;
receive a first encrypted version of the file from a client associated with the first request;
decrypt the first encrypted version to obtain an unencrypted version of the file;
use the unencrypted version to generate a second encrypted version of the file;
write the second encrypted version to a file store; and
store metadata for the file in a virtual filesystem that is physically separate from the file store.

13. The apparatus of claim 12, wherein the memory further stores instructions that, when executed by the one or more processors, cause the apparatus to:
receive a second request to read the file from the remote storage system;
match a filename in the second request to the metadata in the virtual filesystem;
use the metadata to retrieve the second encrypted version from the file store;
decrypt the second encrypted version to produce the unencrypted version; and
during decryption of the second encrypted version, use the unencrypted version to generate and transmit a third encrypted version of the file in a response to the second request.

14. The apparatus of claim 13, wherein the memory further stores instructions that, when executed by the one or more processors, cause the apparatus to:
track decryption of the second encrypted version into the unencrypted version during transmission of the third encrypted version; and
when an end of the second encrypted version is reached during generation of the third encrypted version, signal an end of transmission of the file in the response.

15. The apparatus of claim 13, wherein using the metadata to retrieve the second encrypted version from the file store comprises:
obtaining, from the metadata, a mapping of the filename to an obfuscated filename; and
retrieving a file representing the second encrypted version with the obfuscated filename from the file store.

16. The apparatus of claim 12, wherein the memory further stores instructions that, when executed by the one or more processors, cause the apparatus to:
match authentication credentials from the user to a virtual user in a user store;
upon initiation of a user session for the virtual user, create a sandbox for accessing the virtual filesystem for the virtual user; and
configure the sandbox with a set of permissions for the virtual user.

17. The apparatus of claim 16, wherein creating the sandbox for accessing the virtual filesystem for the virtual user comprises:
creating a virtual root directory representing the virtual filesystem; and
creating a set of virtual files comprising the metadata within the virtual root directory.

18. The apparatus of claim 12, wherein using the unencrypted version to generate the second encrypted version of the file comprises:
padding a portion of the unencrypted version prior to encrypting the portion.

19. A remote storage system, comprising:
a file store;
a virtual filesystem that is physically separate from the file store; and
a server comprising a non-transitory computer-readable medium comprising instructions that, when executed, cause the system to:
receive a first request from a user to write a file to the remote storage system;
receive a first encrypted version of the file from a client associated with the first request;
decrypt the first encrypted version to obtain an unencrypted version of the file;
use the unencrypted version to generate a second encrypted version of the file;
write the second encrypted version to the file store; and
store metadata for the file in the virtual filesystem.

20. The remote storage system of claim 19, wherein the non-transitory computer-readable medium of the server further comprises instructions that, when executed, cause the system to:
receive a second request to read the file from the remote storage system;
match a filename in the second request to the metadata in the virtual filesystem;
use the metadata to retrieve the second encrypted version from the file store;
decrypt the second encrypted version to produce the unencrypted version; and
during decryption of the second encrypted version, use the unencrypted version to generate and transmit a third encrypted version of the file in a response to the second request.
